(19) United States
(12) Patent Application Publication
(10) Pub. No.: US 2026/0147798 A1
(43) Pub. Date: May 28, 2026

(54) LIGHTWEIGHT METHOD FOR HALLUCINATION DETECTION IN RETRIEVAL AUGMENTED GENERATION BASED SYSTEMS

(71) Applicant: Dell Products L.P., Round Rock, TX (US)

(72) Inventors: Amanda Ortega de Castro Ayres, Paulínia (BR); Jéssica Soares dos Santos, Rio de Janeiro (BR); Pablo Nascimento da Silva, Niterói (BR)

(21) Appl. No.: 18/958,378

(22) Filed: Nov. 25, 2024

(51) Int. Cl. G06F 16/3329

(52) U.S. Cl. CPC G06F 16/33295

(57) ABSTRACT

Hallucination detection in retrieval augmented generation (RAG) systems. An answer generated by a RAG system is received by a hallucination detection system. Predetermined rules are applied to determine whether the answer is a hallucination by definition, whether the answer should be skipped, and/or whether generic text should be discarded. Features for the answer are determined and a model determines whether the answer is a hallucination. The model is trained using engineered features and hyperparameters are optimized.

### TECHNOLOGICAL FIELD OF THE DISCLOSURE

Embodiments disclosed herein generally relate to detecting hallucinations in systems that include machine learning models including retrieval augmented generation (RAG) based systems. More particularly, at least some embodiments relate to systems, hardware, software, computer-readable media, and methods for a lightweight hallucination detection module for use in RAG based systems.

### BACKGROUND

Large Language Models (LLMs) are artificial intelligence/machine learning models trained with large amounts of textual data. LLMs are increasingly able to understand and generate human-like natural language. LLMs are often used in a variety of applications including virtual assistants, question/answer applications, chat bot applications, and the like.

One problem with LLMs is that they may hallucinate when generating a response. In the context of LLMs, a hallucination occurs when the model outputs, for example, non-factual information. For example, an LLM may return an answer to a user query that is wrong or non-responsive. Retrieval augmented generation (RAG) is a technique that provides additional information to the LLMs by selecting a list of documents (sources) from a knowledge database that may be relevant to the context or of the question or query. RAG systems allow models to use proprietary knowledge, which is private and up to date and which was not presented to the model during training.

This technique may also be adopted to prevent hallucinations. More specifically, the LLM can receive instructions to answer questions or queries using only the contextual information of a list of sources that are placed within the prompt. However, even RAG-based systems may hallucinate. Hallucinations occur in RAG systems, for example, when the LLM mixes information from different sources that do not refer to the same topic, uses internal knowledge that is not related to the question or query, or fabricates non-existent information.

To diminish this problem, conventional solutions use LLM models specifically finetuned to identify hallucinations. However, the application of such models requires substantial hardware usage for both training and inference operations. Further, F1-scores (a metric for measuring precision in identifying true hallucinations) have substantial room for improvement. In addition to this unsatisfactory performance, the time required by finetuned models to identify hallucinations may prevent these solutions from being adopted in production environments.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a hallucination detection system configured to detect hallucinations in a system such as a RAG based system;

FIG. 2 discloses aspects of a hallucination dataset configured to train a model to detect hallucinations;

FIG. 3A discloses aspects of determining or calculating features of an answer;

FIG. 3B discloses additional aspects of determining or calculating features of an answer;

FIG. 3C discloses additional aspects of determining or calculating features of an answer;

FIG. 4 discloses aspects of results that compare performance of embodiments of the invention with the performance of other models with regard to hallucination detection; and

FIG. 5 discloses aspects of a computing device, system, or entity.

### DETAILED DESCRIPTION OF SOME EXAMPLE EMBODIMENTS

Embodiments disclosed herein generally relate to detecting hallucinations in machine learning models and systems. More particularly, at least some embodiments relate to systems, hardware, software, computer-readable media, and methods for detecting hallucinations in large language model (LLM) based applications that include retrieval augmented generation (RAG).

Embodiments of the invention relate to detecting hallucination in answers generated by LLM systems that use RAG, and a hallucination detection method that runs smoothly on simple hardware. Embodiments of the invention are configured to identify potential hallucinations in answers and allow LLM-based conversational systems (and other LLM-based applications) to operate more efficiently and effectively, thereby improving user experience.

Embodiments of the invention, when predicting whether an answer is a hallucination, may rely on various models. However, embodiments of the invention may use models that are simple and able to run efficiently using comparatively less computing resources.

In one example, predicting hallucinations may include using transformer models. Transformer models may have a statistical understanding of the language on which they have been trained due to the very large amounts of raw text used during the training stage.

Transformer models may include an encoder and a decoder. The encoder receives an input and builds a representation of the input, in the form of embeddings, which are mathematical representations of the input in multidimensional arrays. The decoder uses the output of the encoder, along with other inputs, to generate a target sequence. The output may be a summary or other representation of the encoder's output. Thus, the model may be optimized for generating outputs that may vary according to the task for which the transformer model is trained.

A transformer model may be used, by way of example, for applications including sentence classification, text generation, translation and summarization. Embodiments of the invention are discussed in the context of answering questions (a question answering task) but may be implemented in other applications. However, for the questioning answer task, only the decoder is needed in some examples. The decoder may be used for the purpose of generating answers in an LLM-based system using RAG and are used herein in the context of hallucination detection. More specifically, the decoder may be used to generate features that reflect a correspondence between a question, a context, and an answer.

In addition, embodiments of the invention may include calculating or determining the similarity between two texts (e.g., two strings). More specifically, hallucination detection in RAG models may include the task of verifying or determining whether an answer produced by the LLM-based system is supported by the text contained in the provided sources and/or whether sources and questions are adherent.

The hallucination detection task in RAG models may be interpreted as a process of whether the answer produced by the LLM-based system is supported by the text contained in the provided sources and/or whether the sources and the question are adherent. Consequently, the similarity between pairs of texts may be evaluated.

Various methods may be used to determine the similarity of texts or between pairs of texts. Example methods include lexical methods and semantic methods. Lexical methods relate to the word frequency or word overlapping between pairs of texts. Semantic methods capture the semantic meaning of sentences, which is distinct from considering only the raw words as in lexical methods.

Example lexical methods include the following methods.

### 1. TF-IDF (Term Frequency-Inverse Document Frequency)

TF-IDF is a product of a statistical measures term frequency (TF) and inverse document frequency (IDF). TD-IDF reflects the importance of a word in a text relative to a collection of texts. The term frequency, TF(t, d), is the relative frequency of term t within a document d:

$$T F ( t , d ) = \frac{{f}_{t , d}}{{\sum }_{{t}^{′} ∈ d} {f}_{{t}^{′} , d}} .$$

The inverse document frequency, IDF(t, D), is a measure of the rarity of the term t across all documents in the collection D:

$$IDF ( t , D ) = log \frac{\vert D \vert}{\vert \{ d : d ∈ D and t ∈ d \} \vert} .$$

In this example, |D| is the number of documents in the collection and |{d: d∈D and t∈d}| is the number of documents where the term t appears.

After calculating the TF-IDF vectors for the pairs of documents, the similarity between the pairs of documents (or pairs of texts), using a cosine similarity metric in one example, can be calculated. The similarity measures a cosine of an angle between two vectors, which varies from −1 to 1. In this example, 1 indicates identical documents, 0 indicates no similarity and −1 indicates completely dissimilar documents.

### 2. ROUGE (Recall-Oriented Understudy for Gisting Evaluation)

ROUGE is a set of metrics designed for evaluating automatic summarization. The measures count the number of overlapping units such as n-gram, word sequences and word pairs between the computer-generated and the ideal human-created summaries. Common metrics in ROUGE are ROUGE-N and ROUGE-L.

An example of ROUGE metrics considers the following reference R and candidate summary C:

R: The baby is in the crib. C: The baby and the mom.

### ROUGE-N

ROUGE-N is an overlap of n-grams between the generated text and the reference.

ROUGE-1 considers unigrams. ROUGE-1 precision can be computed as a ratio of the number of unigrams in C that also appear in R (the words “the”, “baby” and “the”), over the number of unigrams in C. Rouge-1 recall, on the other hand, compares the number of unigrams in C that appear also in R over the number of unigrams in R:

$$ROUGE - {1}_{p r e c i s i o n} = \frac{3}{5} = 0.6$$

$$ROUGE - {1}_{recall} = \frac{3}{6} = 0.5 .$$

The ROUGE-1 F1-score can be directly obtained from the ROUGE-1 precision and the ROUGE-1 recall using the standard F1-score formula:

$$ROUGE - {1}_{F 1 - score} = 2 \cdot \frac{precision \cdot recall}{precision + recall} = 0.54 .$$

ROUGE-2 considers 2-grams. ROUGE-2 precision is a ratio of the number of 2-grams in C that appear also in R (only the 2-gram “the baby”), over the number of 2-grams in C. ROUGE-2 recall compares the number of 2-grams in C that appear in R over the number of 2-grams in R:

$$ROUGE - {2}_{p r e c i s i o n} = \frac{1}{4} = 0 \text{.25}$$

$$ROUGE - {2}_{r e c a l l} = \frac{1}{5} = 0.2 .$$

Therefore, the F1-score is:

$$ROUGE - {2}_{F 1 - score} = 2 \cdot \frac{precision \cdot recall}{precision + recall} = 0.22 .$$

### ROUGE-L

ROUGE-L is founded on the longest sequence of words (not necessarily consecutive, but still in order) that is shared between model output and reference. For our example, the longest sequence of words is the 3-gram “the baby the”, which appears in both R and C. ROUGE-L precision is a ratio of the length of this sequence over the number of unigrams in C, while ROUGE-L recall is a ratio of the length of this sequence over the number of unigrams in R:

$$ROUGE - {L}_{p r e c i s i o n} = \frac{3}{5} = 0.6$$

$$ROUGE - {L}_{r e c a l l} = \frac{3}{6} = 0.5 .$$

Therefore, the F1-score is:

$$ROUGE - {L}_{F 1 - score} = 2 \cdot \frac{precision \cdot recall}{precision + recall} = 0.5 5 .$$

Other ROUGE metrics such as ROUGE-S may be considered.

Example semantic methods include the following methods.

### 1. Natural Language Inference (NLI)

Natural language inference indicates whether there is a directional relationship between two text strings or fragments: a premise P and a hypothesis H. This relationship may be entailment, contradiction, or neutral. Sentence P is considered to be in an entailment relationship with sentence H only if it can be inferred from P that H is true. Sentence P is considered to be in a contradictory relationship with sentence H only if it can be inferred from P that H is false. Finally, sentence P is considered to be in a neutral relationship with sentence H only if the truth of H cannot be inferred from P.

### 2. Semantic Similarity by Embeddings Similarity

Semantic similarity methods can be calculated using the similarity of their embeddings. The embedding is obtained at the output of the encoder block of a transformer architecture. An encoder, give an input text, generates an output that includes a high dimensional array that captures the semantic information of the text. Semantically comparing two texts includes generating their embeddings and then measuring their similarity mathematically (e.g., cosine similarity, Euclidean distance or dot product).

### 3. Semantic Similarity by Employing Hallucination Detection Finetuned Models

It is also possible to calculate the semantic similarity between a pair of texts using embeddings from hallucination detection finetuned models. These models are trained initially on NLI data, before being further finetuned on summarization datasets, with samples annotated for factual consistency.

As previously stated and by way of example, a hallucination is identified when an answer is not consistent the documents (or sources) retrieved by the RAG pipeline and included in the LLM's context. Embodiments of the invention can be performed on simple hardware and employ simple calculations and/or models.

In one example, a set of features are built to train a hallucination detection model. These features may combine natural language processing (NLP) techniques with specifically designed features to address the unique aspects of hallucinations. This feature set is employed to develop/train a machine learning model that outputs hallucination scores. Users may adjust and set hallucination thresholds for their specific circumstances.

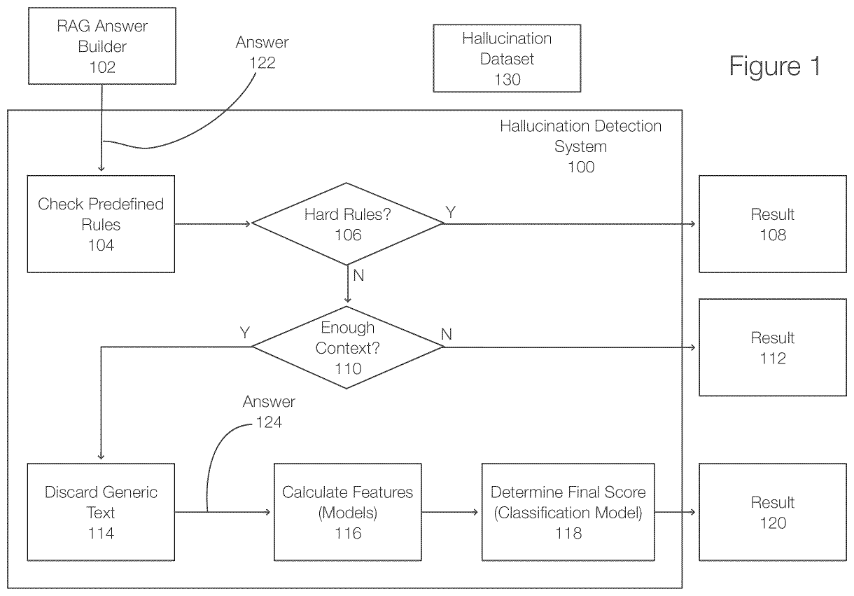

FIG. 1 discloses aspects of a hallucination detection system. The hallucination detection system 100 may include a model that is trained using a hallucination dataset 130 and/or models configured to generate features or feature values. The dataset 130, in one example, is a labeled dataset and is configured for training a model to detect hallucinations. In one example, the hallucination dataset 130 is used to train a classification model employed when determining 118 a final score (e.g., probability of hallucination) for an answer. A classification model may generate a probability about whether a particular answer is a hallucination when deployed.

The hallucination dataset 130 may be an existing dataset, an internal dataset, or the like. In one example, the dataset 130 may include elements or entries formatted as tuples. The format of the tuples is (query, list of sources to be used as context, answer). A hallucination flag that can be true when the answer is considered to be a hallucination or false when the answer is covered by the content of the list of sources, and is not a hallucination. Alternatively, examples of hallucination tuples with hallucination flag equal to true can be artificially generated by shuffling answers of domain specific datasets that contain a query, a list of prompt sources and its respective LLM answer.

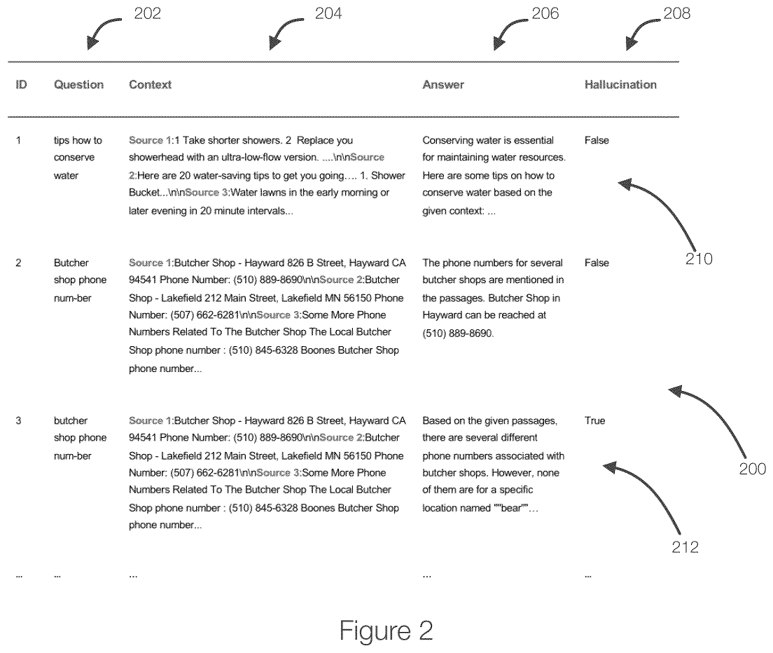

FIG. 2 discloses an example of a hallucination dataset. The dataset 200, which is an example of the hallucination dataset 130, includes entries or elements formatted in tuples. The tuple 210, for example, includes a question 202, a context 204, and an answer 206. The tuple 210 may also be associated with a flag 208 or a label. In the tuple 210, the question 202 may be an example of a query. The context 204 identifies sources from that are used to provide context to a prompt. The sources may be identified by a RAG system. The answer 206 is generated by an LLM in response to the contextualized prompt. The flag 208 indicates whether the answer 206 is a hallucination. With respect to the tuple 210, the tuple 210 is not a hallucination (false). However, the tuple 212 is a hallucination in the dataset 200.

As previously stated, FIG. 1 discloses aspects of the hallucination detection system 100 deployed in a LLM-based application using RAG. In this example, the LLM-based application is a question/answer application. FIG. 1 assumes that a query has been submitted to the application and that an answer has been generated and/or that sources for the answer are identified.

Thus, the hallucination detection module 100 is positioned, in one example, to determine whether the answer is a hallucination prior to providing the answer to the user. The RAG answer builder 102 thus generates input to the module 100 that includes an answer to a query and the prompt or prompt data. This allows the input to the system 100 to be a tuple similar to the tuples used to train the hallucination detection model.

The architecture or framework of a hallucination detection system 100 in an LLM based systems using RAG is presented in FIG. 1. The system 100 receives as input the answer generated by the RAG Answer Builder 102, together with the prompt data used to generate the answer. The system 100 generates an output regarding whether the answer is a hallucination.

In FIG. 1, an output, the answer 122, of the RAG answer builder 102 is received at the hallucination detection system 100 and may be formatted as a tuple. Initially, the system 100 checks 104 the answer 122 with predefined rules of various types. In one example, a system administrator or other user may define rules to be checked 104. The types of questions may vary and may be evaluated in a particular order.

FIG. 1 illustrates an example with three types of rules: hard rules, skip answer rules, and discarding rules. In one example, hard rules may define a hallucination. More specifically, hard rules may be defined that, when satisfied, define a hallucination by default. Skipping rules may define situations in which the hallucination detection operations are skipped. Discarding rules may discard portions of the answer.

In the example of FIG. 1, the rules are checked 104 in the following order: hard rules, skipping rules, and discarding rules. Hard rules 106 are evaluated or applied to the answer 122 received

For example, the hard rules 106 may relate to domain-dependent hallucinations. An answer that contains domain-dependent acronyms or uniform resource locators (URLs) for external sites are deemed to be a hallucination by the hard rules that include domain-dependent hallucinations. If a hard rule is satisfied (Y at 106) the result 108 output by the hallucination detection system 100 is that the answer 122 is considered to be a hallucination. The result 108 includes a hallucination score of 100%.

If the hard rules are not satisfied (N at 106), the system 100 moves to another rule type or category. Skipping rules relate to answers that do not include sufficient context. For example, an answer of “The context provided does not answer the question” may occur when the sources in the prompt context do not provide enough information to answer the user's question or query. This type of answer is skipped. More specifically, if the answer 122 does not include sufficient context (N at 110), the result 110 of the system 100 includes a hallucination score of 0 and the answer is determined to not be a hallucination.

If the answer includes sufficient context (Y at 110) according to the defined skipping rules, the hallucination detection system 100 proceeds to another type of rules. In this example, discarding rules are applied after determining that the context is sufficient (Y at 110). Discarding rules are configured to discard 114 generic text. In one example, a set of generic sentences may be defined to be discarded. For example, a phrase such as “Please let me know if you have any questions” or other sentences that appear in the prompt instructions but are not part of the sources may be discarded.

To capture variations of default sentences when determining whether an answer has enough context 110 or includes generic texts 114, embeddings semantic similarity may be adopted. In this example, pairs of sentences are compared using their embeddings and when the semantic similarity is higher than a given threshold, the sentences are deemed to be variations of answers to be skipped or variations of sentences to be discarded and are treated accordingly. For example, a phrase such as “please let me know if you have any questions” may be skipped. The discarding rules may discard sentences that are sufficiently close semantically (semantic similarity higher than a threshold) to this phrase.

FIG. 1 thus illustrates the rules are checked 104 and applied (e.g., hard rules at 106, skipping rules at 110, and discarding rules at 114). Depending on whether the rules are violated or based on the outcome of the rules, the output of the system 100 may deem an answer to be/not be a hallucination at result 108 or 112.

Once the predefined rules have been checked 104 by applying the rules to the answer 122, the answer 124 is generated. The answer 124 may differ from the answer 122, by way of example, in that some sentences have been discarded.

The system 100 calculates 116 features for the answer 124. The features that are calculated may be a result of feature engineering. The classification model at 118 may also be trained using the features calculated at 116.

Feature engineering allows various features to be explored. This allows features that assist in identifying hallucinations to be identified and included in the system 100. Once the feature set is engineered and the model is trained, the input to the model may be generated by determining values for the relevant features.

The following description describes some of the features that may be identified during feature engineering and identifies manners in which the features are calculated when the system is operating.

In some embodiments, features related to syntactic functions of the words may be calculated.

Word frequency similarity score is an example of a syntactic feature. To calculate the text similarity between the answer 124 and sources in the context, a cosine similarity metric may be used. After calculating the TF-IDF vectors for pair (answer, sources), cosine similarity is applied to determine the similarity.

Rouge metrics are additional examples of syntactic features. Computing recall, precision, and F1-score allow the answer to be compared with the provided context.

In addition to features related to the syntactic functions of the words in the answer, other features relating to the semantic meaning of sentences, may be determined.

An adherence score between a question and a context is an example of a semantic feature. For this feature, more specifically, an adherence score between the question and the sources in the context passed to the RAG system is determined. This adherence score can be determined by a transformer model, such as an extractive answering model or a hallucination detection finetuned model. Calculating this adherence scores indicates whether the context generated by the source manager module of the LLM-based system is aligned with the question the user entered. To generate these adherence scores, the sources in the context can be considered as unique text or considered separately. When the sources are considered separately, a group of features can be generated from the scores calculated for each source. Thus, the minimum score, the maximum score, the mean and standard deviations may be determined as features.

Another feature is an adherence score between the answer and the context. Similar to the adherence scores between the question and the context, the adherence score between the answer and the context may be generated. In one example, the answer is split into sentences to improve adherence detection.

Another feature is to measure or calculate adherence scores between each sentence in the answer and each source in the context.

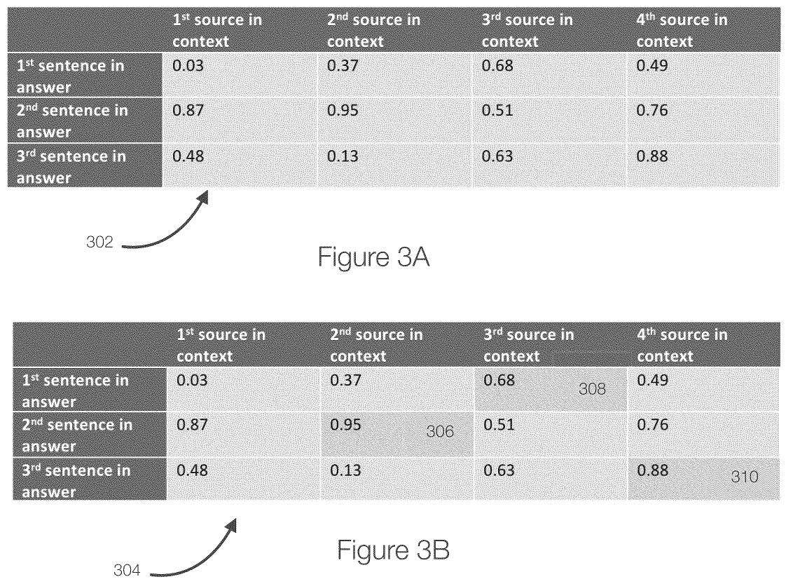

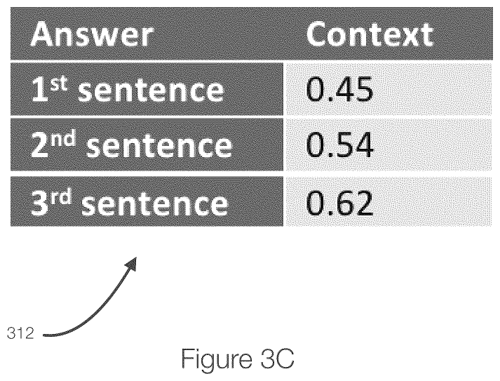

FIG. 3A discloses aspects of determining adherence scores between each sentence in the answer and each source in the context. FIG. 3A illustrates a table 302 that splits the answer into sentences (3 sentences) and the context into sources (4 sources). The adherence scores are illustrated in the table 302.

In FIG. 3A, all of the adherence scores in the table 302 are considered collectively to calculate various features. When the scores in the table 302 are considered collectively, the following features are identified: Min=0.03, Max=0.95, Mean=0.57, and Standard Deviation=0.28. FIG. 3B discloses aspects of calculating similar features in a different manner. FIG. 3B identifies the most adherent source (entries 306, 308, 310) for each corresponding sentence in the table 304. The most adherent sources, respectively, for first, second and third sentences, are the third, second, and fourth sources in the context. In n FIG. 3B, the same features calculated in FIG. 3A are computed using the best value for each sentence. This results in: Min=0.68, Max=0.95, Mean=0.84, and Standard Deviation=0.11

Another feature can be obtained by calculating a fraction of the sentences in the answer which have an adherence score to a source in the context above a threshold divided by the number of sentences. Considering a threshold of 0.7, this results in a fraction of 0.67 (2 divided by 3 because only two of the adherence scores (entries 306 and 310) are above the threshold).

FIG. 3C illustrates adherence scores between each sentence in the answer and all of the sources in the context. The table 312 illustrates that the first sentence of the answer has an adherence score of 0.45 to the whole context (e.g., all of the sources together). Using the table 312, the metrics or features are: Min=0.45, Max=0.62, Mean=0.54, and Standard deviation 0 0.07.

Another feature is to determine NLI scores between the context and the answer. This may include computing textual entailment scores (entailment, neutral, contraction)). This feature checks to determine if there is a direction relationship between the context and the answer.

These examples of features can be computed using equations, generated by specialized models, or the like.

Once feature engineering has determined or identified a feature set, the hallucination detection model is trained. In one example, hyperparameter optimization capable of selecting the best model and its parameters from a dataset and set of metrics is employed. For example, the results obtained using different configurations (features, models, metrics, dataset) are compared and one goal is to select the optimum configurations.

The configuration possibilities include the list of potential features explored in the feature engineering, the machine learning classification algorithms (e.g., Decision Trees, Gaussian Process, Random Forest, SVC, Naïve Bayes, a list of machine learning metrics such as precision, recall, F1-score, accuracy, and the hallucination data set selected.

The calculation of the best parameters may be guided by the optimization of an objective function and by the chosen algorithm for sampling hyperparameters and pruning efficiently unpromising trials. For example, for the hallucination task, the objective function could be improving the precision metric to maximize the number of hallucination cases correctly classified as hallucination by the trained model. Some examples of algorithms for sampling the hyperparameters are Grid or Random Search, Tree-structured Parzen Estimator and Gaussian process-based. Some examples of pruning algorithms are Median pruning, Asynchronous Successive Halving and Hyperband.

In this example, the results of hyperparameter optimization is a classification model. The classification model determines 118 the final score, which is reflected in the result 120. The result 120 may be a probability of whether the answer is a hallucination.

Thus, the classification model is trained to detect hallucination in RAG answers. In some embodiments, a user may be able to adjust the desired level of hallucination. To adjust the level of hallucination (whether an answer is deemed to be a hallucination), an optimization metric may be employed. This metric checks to determine whether the hallucination detection performance of a trained model increases/decreases when the hallucination level changes.

As illustrated in FIG. 1, the hallucination detection system 100 is integrated in an LLM-based system using RAG. The system 100 is called, in one example, after the answer builder 102 and returns a score or result between 0 and 100%. Higher scores indicate a higher likelihood that the answer is a hallucination. The score may depend on the threshold or level of hallucination set by a user or set in another manner.

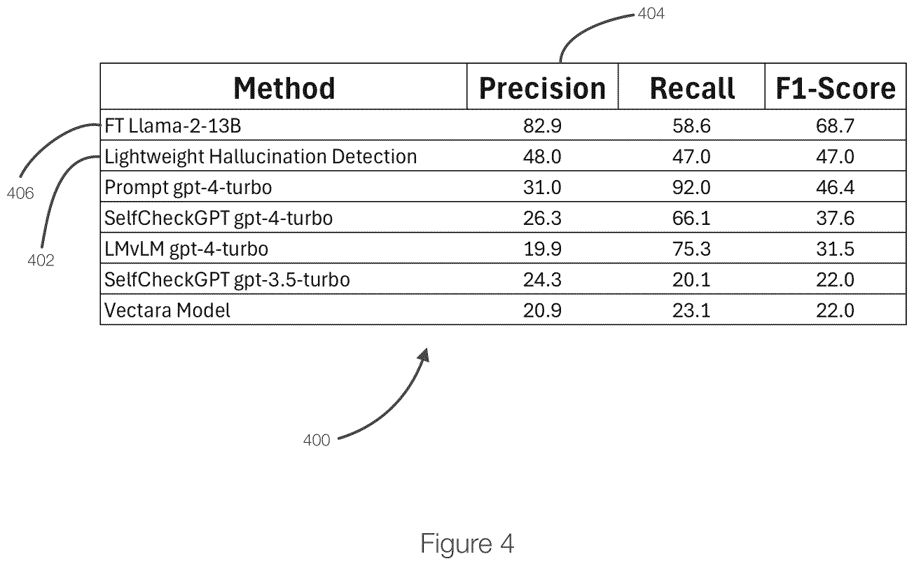

FIG. 4 discloses aspects of results that compare performance of embodiments of the invention with the performance of other models with respect to hallucination detection. The table 400 includes results with respect to a dataset RAGTruth. The configuration selected from hyperparameter optimization includes the following:
list of features: word frequency similarity score and adherence scores between answer and context;
final machine learning classification algorithm: Gaussian Process; and
machine learning optimized metric: precision.

The table 400 illustrates compares performance of a hallucination system 402, which is an example of the system 100 in FIG. 1 with regard to other methods and in the context of optimizing a precision metric 404. The system 402 placed second behind the system 406, which is finetuned for hallucination detection.

Although the system 406 had better performance than the system 402, the application of the system 406 is intensive in hardware usage, making it difficult to be used in productions environments. The system 402, in contrast, achieves good performance with reasonable processing, and can be integrated with RAG-based systems. Further, the other systems employ a powerful LLM (either using gpt4 or gpt3.5), while embodiments of the invention may advantageously rely on handcrafted or engineered features, small models and hyperparameter tunning.

Embodiments of the invention relate to a hallucination detection system that uses novel features combining lexical, semantic and predefined rules to detect hallucinations in LLMs that use RAG. In one example, the best features are selected based on, by way of example, the machine learning classifier, the objective function based on common metrics, and applied to a specific hallucination dataset.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, prompt context generation operations, machine learning model, including LLM, operations, query or question operations, multiple model operations for context generation, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. An object may be a portion of a document image.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method receiving an answer to a question from a retrieval augmented generation system into a hallucination detection system, checking the answer with predefined rules, calculating feature values for the answer, and determining a score for the answer using a model, wherein the score is a probability of whether the answer is a hallucination.

Embodiment 2. The method of embodiment 1, wherein the answer includes an answer to the question and sources retrieved by the retrieval augmented generation system.

Embodiment 3. The method of embodiment 1 and/or 2, wherein the predefined rules comprise hard rules configured to determine whether the answer is a hallucination or not a hallucination, wherein the hallucination detection system outputs a score of 100% hallucination when the answer satisfies at least one of the hard rules.

Embodiment 4. The method of embodiment 1, 2, and/or 3, wherein the predefined rules comprise skipping rules configured to determine whether the answer has sufficient context, wherein the hallucination detection system outputs a score of 100% hallucination when the answer satisfies at least one of the skipping rules.

Embodiment 5. The method of embodiment 1, 2, 3, and/or 4, wherein the predefined rules comprise discarding rules configured to determine whether the answer includes generic text, wherein generic text is discarded from the answer when the discarding rules are satisfied.

Embodiment 6. The method of embodiment 1, 2, 3, 4, and/or 5, further comprising determining feature values, wherein at least one of the feature values is determined by a model.

Embodiment 7. The method of embodiment 1, 2, 3, 4, 5, and/or 6, wherein the features include one or more of a word frequency similarity score, one or more ROUGE scores, an adherence score between the question and a context, an adherence score between the answer and the context, adherence scores between each sentence in the answer and each source in the context, adherence scores between each sentence and all sources in the context, textual entailment scores between the context and the answer.

Embodiment 8. The method of embodiment 1, 2, 3, 4, 5, 6, and/or 7, further comprising inputting the features into the model to generate an output, wherein the output is a probability that the answer is a hallucination, wherein the model is a classification model.

Embodiment 9. The method of embodiment 1, 2, 3, 4, 5, 6, 7, and/or 8, further comprising performing feature engineering prior to training the classification model, and training the classification model with a hallucination dataset and the engineered features.

Embodiment 10. The method of embodiment 1, 2, 3, 4, 5, 6, 7, 8, and/or 9, further comprising performing hyperparameter optimization using multiple configurations of features, models, metrics, and the hallucination dataset.

Embodiment 11. The method of embodiment 1, 2, 3, 4, 5, 6, 7, 8, 9, and/or 10, further comprising adjusting a threshold to change a level of hallucination.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

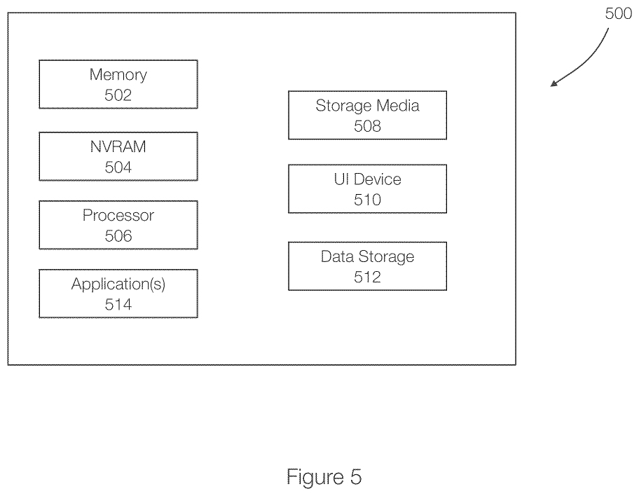

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. Document understanding, context generation, prompt engineering, and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
receiving an answer to a question from a retrieval augmented generation system into a hallucination detection system;
checking the answer with predefined rules;
calculating feature values for the answer; and
determining a score for the answer using a model, wherein the score is a probability of whether the answer is a hallucination.

2. The method of claim 1, wherein the answer includes an answer to the question and sources retrieved by the retrieval augmented generation system.

3. The method of claim 1, wherein the predefined rules comprise hard rules configured to determine whether the answer is a hallucination or not a hallucination, wherein the hallucination detection system outputs a score of 100% hallucination when the answer satisfies at least one of the hard rules.

4. The method of claim 1, wherein the predefined rules comprise skipping rules configured to determine whether the answer has sufficient context, wherein the hallucination detection system outputs a score of 100% hallucination when the answer does not have sufficient context.

5. The method of claim 1, wherein the predefined rules comprise discarding rules configured to determine whether the answer includes generic text, wherein generic text is discarded from the answer when the discarding rules are satisfied.

6. The method of claim 1, further comprising determining feature values, wherein at least one of the feature values is determined by a model.

7. The method of claim 6, wherein the features include one or more of a word frequency similarity score, one or more ROUGE scores, an adherence score between the question and a context, an adherence score between the answer and the context, adherence scores between each sentence in the answer and each source in the context, adherence scores between each sentence and all sources in the context, textual entailment scores between the context and the answer.

8. The method of claim 7, further comprising inputting the features into the model to generate an output, wherein the output is a probability that the answer is a hallucination, wherein the model is a classification model.

9. The method of claim 8, further comprising performing feature engineering prior to training the classification model, and training the classification model with a hallucination dataset and the engineered features.

10. The method of claim 9, further comprising performing hyperparameter optimization using multiple configurations of features, models, metrics, and the hallucination dataset.

11. The method of claim 1, further comprising adjusting a threshold to change a level of hallucination.

12. A non-transitory storage medium having stored therein instructions that are executable by one or more hardware processors to perform operations comprising:
receiving an answer to a question from a retrieval augmented generation system into a hallucination detection system;
checking the answer with predefined rules;
calculating feature values for the answer; and
determining a score for the answer using a model, wherein the score is a probability of whether the answer is a hallucination.

13. The non-transitory storage medium of claim 12, wherein the answer includes an answer to the question and sources retrieved by the retrieval augmented generation system.

14. The non-transitory storage medium of claim 12,
wherein the predefined rules comprise hard rules configured to determine whether the answer is a hallucination or not a hallucination, wherein the hallucination detection system outputs a score of 100% hallucination when the answer satisfies at least one of the hard rules,
wherein the predefined rules comprise skipping rules configured to determine whether the answer has sufficient context, wherein the hallucination detection system outputs a score of 100% hallucination when the answer satisfies at least one of the skipping rules, and
wherein the predefined rules comprise discarding rules configured to determine whether the answer includes generic text, wherein generic text is discarded from the answer when the discarding rules are satisfied.

15. The non-transitory storage medium of claim 12, further comprising determining feature values, wherein at least one of the feature values is determined by a model.

16. The non-transitory storage medium of claim 15, wherein the features include one or more of a word frequency similarity score, one or more ROUGE scores, an adherence score between the question and a context, an adherence score between the answer and the context, adherence scores between each sentence in the answer and each source in the context, adherence scores between each sentence and all sources in the context, textual entailment scores between the context and the answer.

17. The non-transitory storage medium of claim 16, further comprising inputting the features into the model to generate an output, wherein the output is a probability that the answer is a hallucination, wherein the model is a classification model.

18. The non-transitory storage medium of claim 17, further comprising performing feature engineering prior to training the classification model, and training the classification model with a hallucination dataset and the engineered features.

19. The non-transitory storage medium of claim 18, further comprising performing hyperparameter optimization using multiple configurations of features, models, metrics, and the hallucination dataset.

20. The non-transitory storage medium of claim 12, further comprising adjusting a threshold to change a level of hallucination.
